(19) United States
(12) Patent Application Publication
(10) Pub. No.: US 2002/0150118 A1
(43) Pub. Date: Oct. 17, 2002

(54) Communication system, method and signal for time-slot-coded data transmission

(76) Inventors: Manfred Zinke, Aachen (DE); Mike Wolf, Erfurt (DE)

Correspondence Address: Corporate Patent Counsel, U.S. Philips Corporation, 580 White Plains Road, Tarrytown, NY, 10591, US

(21) Appl. No.: 10/067,045

(22) Filed: Feb. 4, 2002

(30) Foreign Application Priority Data
Feb. 7, 2001 (DE) 10105794.6

(51) Int. Cl. H04B 7/212

(52) U.S. Cl. 370/442; 370/252

(57) ABSTRACT

The invention relates to a communication system with means for transmitting a data stream via a transmission medium by means of time slot coding. A synchronization pattern is provided for insertion into the data stream and is selected in such a way that it differs by a prescribable Hamming distance from all the valid data signals of the time slot coding independently of the respective time slot of the data signals, and that it differs by a prescribable Hamming distance from all time-shifted versions of the synchronization pattern.

The invention relates to a communication system, a method and a signal for time-slot-coded data transmission. In a time-slot-coded transmission system, the coding is performed by means of the temporal position of one or more pulses within a time frame. A modulation method much used for time-slot-coded data transmission is the PPM (Pulse Position Modulation) method, which is suitable both for wire-bound and for wireless communication systems. Within a PPM symbol, 1dL bits are coded by the position of one pulse. Each symbol is subdivided into L time slots, which are also denoted as chips. Via an assignment table, the information to be transmitted determines the position of the chip, which has a “1”, that is to say one pulse. Advantages of PPM transmission reside, for example, in the power efficiency and resistance to high-pass filtering. An example is the 4-PPM mode of IrDa (Infrared Data Association) interfaces. A substantial problem in implementation is the the synchronization of the PPM symbols at the receiving end.

Decoding the transmitted information is possible only if the PPM symbols can be synchronized at the receiving end, that is to say their phase angle is known. If there is simultaneous operation in time division multiplex (TDM) mode, the TDM frames must additionally be synchronized.

It is an object of the invention to create a communication system which permits advantageous synchronization of time-slot-coded data signals. The object further consists in specifying a relevant method and a suitable signal.

With reference to the communication system, this object is achieved according to the invention by a communication system with means for transmitting a data stream via a transmission medium by means of time slot coding, in which a synchronization pattern is provided for insertion into the data stream, in which the synchronization pattern is selected such that it differs by a prescribable Hamming distance from all the valid data signals of the time slot coding independently of the respective time slot of the data signals, and that it differs by a prescribable Hamming distance from all time-shifted versions of the synchronization pattern.

In this communication system, the synchronization pattern has a specific, prescribable Hamming distance relative to all valid data signals of the time slot coding, independently of their phase angle. A valid data signal is understood to be a signal which is formed according to the respective coding rule of the respective time slot coding. In a 4-PPM system, a 4-PPM symbol, for example, consists of 4 time slots in each case, which are also denoted as chips. The coding rule for 4-PPM states that within the time frame of a PPM symbol it is only one chip that may have the value “1” in each case, that is to say that within the time frame of a PPM symbol only one pulse may be present in each case. Moreover, the synchronization pattern has a specific, prescribable Hamming distance relative to all shifted versions of the transmitted synchronization pattern, which is adjoined by valid time-slot-coded symbols.

It is thereby possible for the synchronization pattern to be inserted at any desired moments in time and not only within a training sequence at the start of a data transmission. In the case of ATM (Asynchronous Transfer Mode) data transmission it is possible, for example, to send the pattern before each ATM cell. The correct reception of the next ATM cell is thereby ensured even after a synchronization loss.

In the advantageous embodiment of the communication system as claimed in claim 2, a tolerance with respect to transmission errors that can be selected as required can be achieved, and a reliable synchronization can therefore be achieved, even given poor channels. On the one hand, chip errors can be corrected upon receiving a disturbed synchronization pattern owing to a sufficient Hamming distance between each possible valid data sequence of the time slot coding and the synchronization pattern. On the other hand, the probability of receiving a synchronization pattern by mistake can be kept low.

In the advantageous embodiment of the invention as claimed in claim 3, a new synchronization is performed when a specific threshold value for differences between the received data stream and the synchronization pattern is undershot or just reached. If the threshold value is, for example, C, it is then possible for C errors that have possibly occurred during transmission of the pattern to be corrected. The synchronization pattern differs by a specific number of places from each possible data sequence of the time slot coding, independently of the chip delay thereof, in order that during normal time-slot-coded data transmission no false synchronization should occur through the random imitation of the synchronization pattern because of transmission errors. This number of places is also denoted the Hamming distance. If the magnitude of this number is D, transmission errors must therefore occur within the synchronization pattern length (D-C) for the synchronization pattern to be imitated. In order to ensure recognition of the transmitted synchronization pattern relative to the correct chip clock, the synchronization pattern additionally differs from all the shifted versions of the synchronization pattern and of the synchronization pattern with arbitrarily adjoining time-slot-coded data by a specific Hamming distance E which need not, however, necessarily correspond to the Hamming distance D. If, consequently, a received chip sequence differs from the synchronization pattern only by a specific number of chips, which can be selected depending on requirements and possible outlay, it is assigned to this synchronization pattern and generates a synchronization pulse.

In the advantageous embodiment of the invention as claimed in claim 4, the communication system is a TDMA (Time Division Multiple Access) system. In such a system, the synchronization pattern can be used to carry out simultaneously a frame synchronization of the TDMA time frame and a symbol synchronization of the symbols of the time slot synchronization, for example the PPM symbols.

In the advantageous embodiment of the invention as claimed in claim 5, the comparison of the received chip sequence with the stored synchronization pattern is performed with the aid of an N-phase shift register whose N parallel outputs are compared in pairs with the stored synchronization pattern, for example with the aid of equivalence gates. The outlay for the synchronization detector can be kept low, in particular by virtue of the fact that the addition of the equivalence gate outputs with leading “0” (non-correspondences) takes place only modulo C+2.

The detector generates a synchronization pulse exactly whenever its internally stored pattern of length N corresponds to the last N received chips up to a number of tolerable places or errors. In this case, the synchronization pattern stored in the detector corresponds to the synchronization pattern inserted into the data stream and transmitted, or it constitutes a section of the transmitted synchronization pattern. It is therefore possible for the sent synchronization pattern to be, for example, extended in order to maintain the signal mean value or to satisfy a byte orientation. The comparison of the stored synchronization pattern at the receiving end with the received data stream is performed at each chip clock pulse.

The synchronization detector as claimed in claim 6 can be implemented with particular ease and cost-effectively.

Claim 7 relates to a time-slot-coded signal according to the invention, and claim 8 to a relevant transmission method.

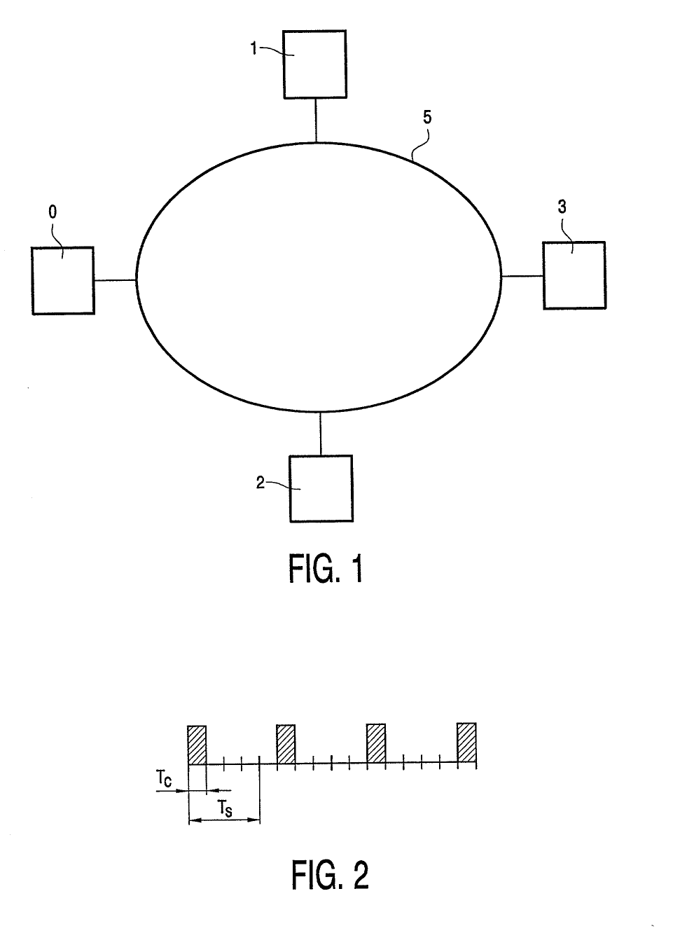

A few diagrammatically represented exemplary embodiments of the invention will be presented in more detail below with reference to the drawing, in FIGS. 1 to 8, in which:

FIG. 1 shows a communication system with four communication nodes which are coupled to a common transmission medium,

FIG. 2 shows the principle of 4-PPM (PPM=Pulse Position Modulation) transmission,

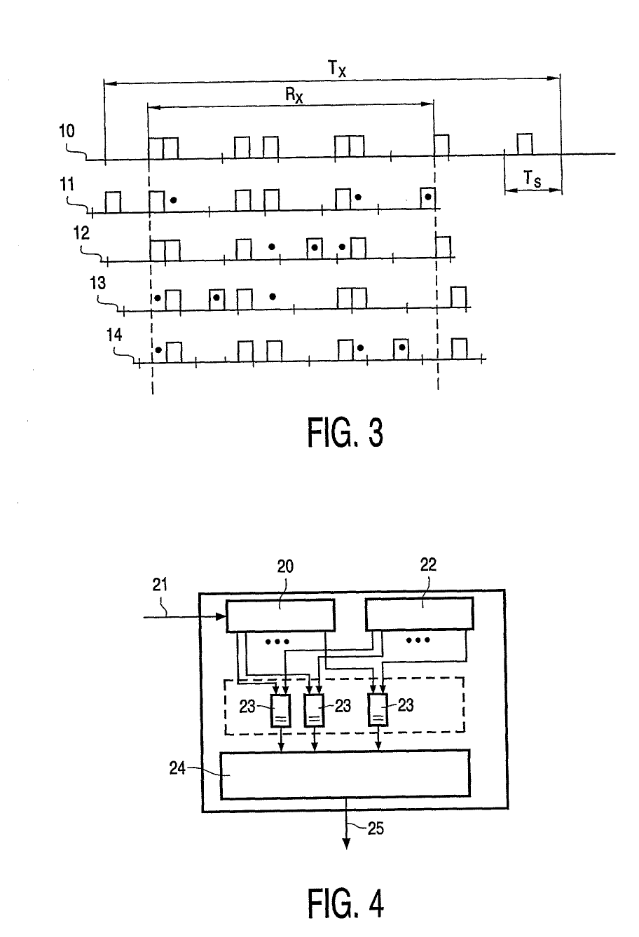

FIG. 3 shows an example of a transmission synchronization pattern Tx and a reception synchronization pattern Rx with assigned valid data signals of the Hamming distance 3,

FIG. 4 shows a synchronization detector for continuous comparison of a received chip sequence with a reception synchronization pattern Rx,

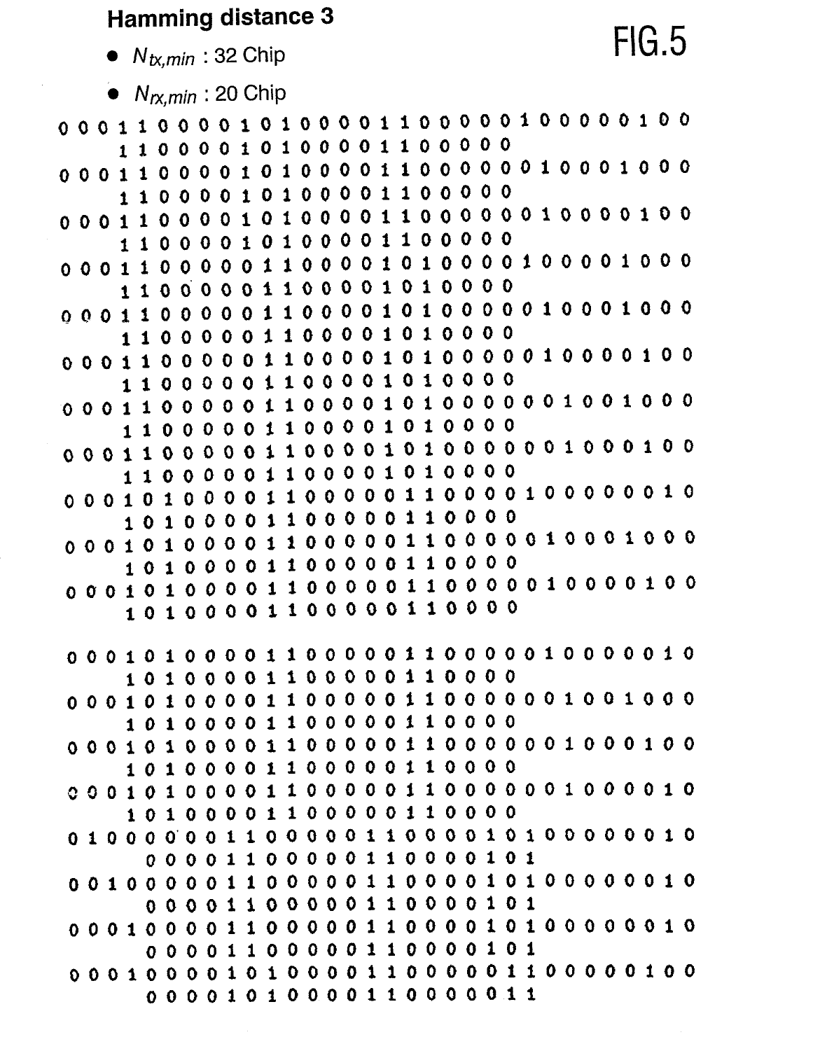

FIG. 5 shows transmission synchronization patterns Tx and reception synchronization patterns Rx for 4-PPM and the Hamming distance 3,

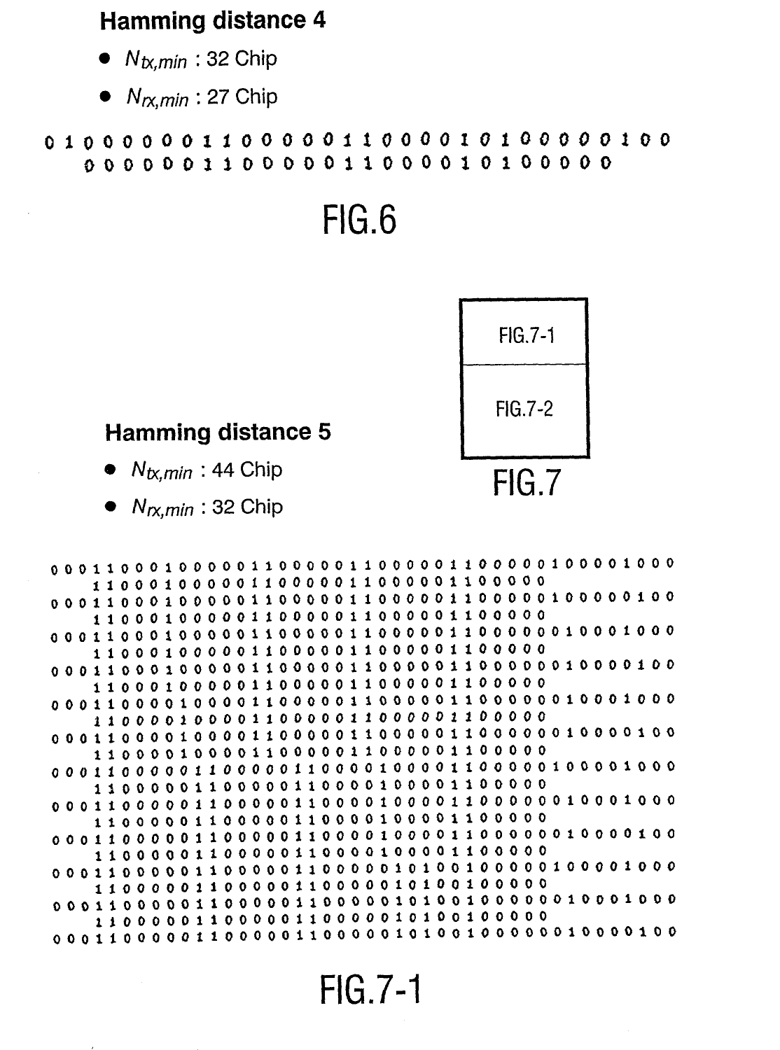

FIG. 6 shows transmission synchronization patterns Tx and reception synchronization patterns Rx for 4-PPM and the Hamming distance 4,

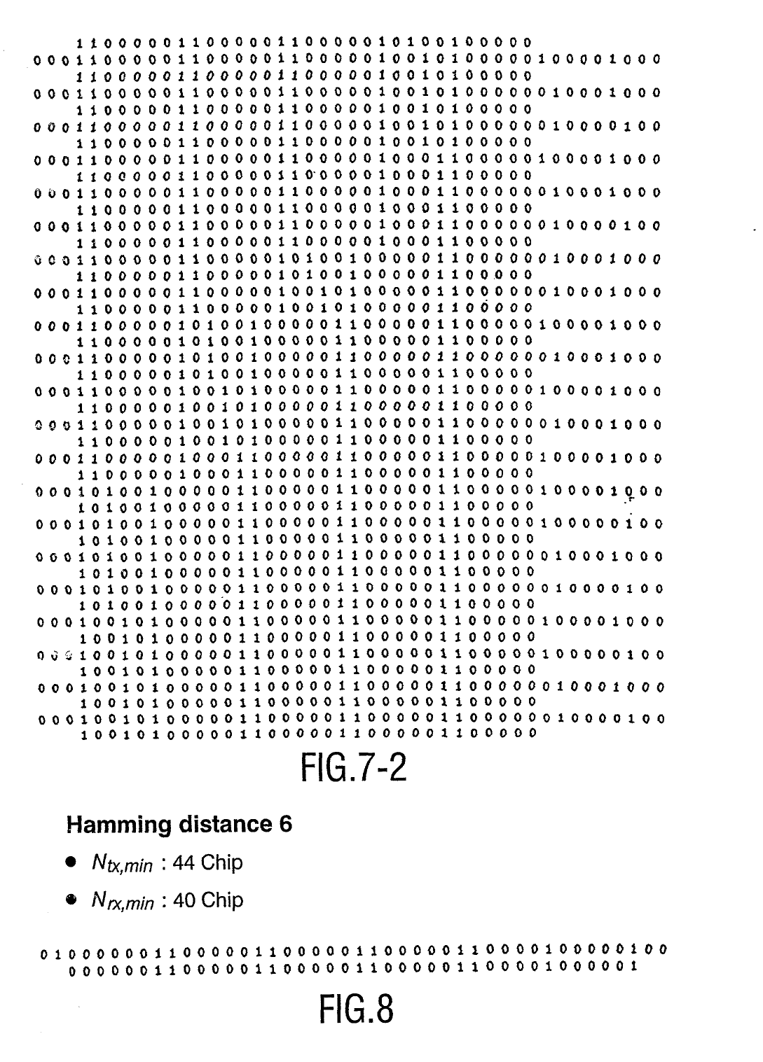

FIG. 7 shows transmission synchronization patterns Tx and reception synchronization patterns Rx for 4-PPM and the Hamming distance 5, and

FIG. 8 shows transmission synchronization patterns Tx and reception synchronization patterns Rx for 4-PPM and the Hamming distance 6.

FIG. 1 shows a communication system with four communication nodes 0, 1, 2 and 3. The four communication nodes 0 to 3 are each coupled to a common transmission medium 5. The common transmission medium 5 is preferably a medium which is suitable for optical data transmission, for example an optical bus system or a channel for the wireless transmission of information by means of infrared. The common transmission medium 5 is preferably used by the four communication nodes in a time-division multiplex method. A time-slot-coded telecommunication is provided for transmitting data via the transmission medium 5. In a time-slot-coded transmission system, the coding is performed by means of the temporal position of one or more pulses within a time frame. A much used modulation method for time-slot-coded data transmission is the PPM (Pulse-Position Modulation) method, which is suitable both for wire-bound and for wireless communication systems.

FIG. 2 shows the principle of 4-PPM (PPM=Pulse Position Modulation) transmission. Such a transmission is used, for example for IrDa (Infrared Data Association) interfaces. Within the 4-PPM symbol, 2 bits are coded by the position of one pulse. Each 4 -PPM symbol is subdivided into 4 time slots, which are also designated chips. The information to be transmitted determines via an assignment table the position of the chip which has a pulse, that is to say the information “1”. The time duration of a chip is designated in FIG. 2 by Tc, and the time duration of a symbol which has 4 chips by Ts. FIG. 2 shows 4 PPM symbols with the time duration of Ts in each case, the first chip in the first symbol having the value “1”, while in the second symbol it is the second chip, in the third symbol the third chip, and in the fourth symbol the fourth chip. This is represented in each case by means of the framed and hatched rectangles.

The transmitted information can be decoded only if the 4-PPM symbols can be synchronized at the receiving end (that is to say their phase angle is known). In order to be able to carry out a synchronization at the receiving end, it is provided to insert a synchronization pattern into the data stream at the transmitting end. It is now provided for the purpose of synchronization at the receiving end to carry out a continuous check of the data stream with regard to the synchronization pattern.

FIG. 3 shows an example of a transmission synchronization pattern Tx and reception synchronization pattern Rx. The transmission synchronization pattern Tx and reception synchronization pattern Rx are plotted as a function of time on the time axis 10, the length of the transmission synchronization pattern being denoted by Tx, and that of the reception synchronization pattern by Rx. It is to be borne in mind that the reception synchronization pattern Rx at the receiving end constitutes only a partial section of the transmission synchronization pattern Tx at the transmitting end. The remaining chips of the transmission synchronization pattern Tx serve the purpose of ensuring specific characteristics such as the mean value of the transmission signal, or else corresponding only to the byte orientation of the transmission. The reception synchronization pattern Rx according to FIG. 3 differs in at least 3 places from each possible valid 4-PPM sequence, and therefore has the Hamming distance 3 relative to all valid data signals of the time slot coding, independently of their phase angle. A valid data signal is understood to be a signal which is formed in accordance with the respective coding rule of the respective time slot coding. In the case of the 4-PPM system according to FIGS. 2 and 3, the coding rule consists in that only one chip may have the value “1” within the time frame of a 4-PPM symbol at any time, that is to say that only one pulse may be present within the time frame of a 4-PPM symbol at any time. Moreover, the reception synchronization pattern Rx at the receiving end has the Hamming distance 3 relative to all the shifted versions of the transmission synchronization pattern Tx which is adjoined by valid 4-PPM symbols.

Respective valid 4-PPM data sequences are illustrated below the time axis 10 in FIG. 3, the data sequences being selected in each case so as to result in the largest possible number of correspondences with the reception synchronization pattern Rx. In the data sequence illustrated on the time axis 11, the symbol clock for the 4-PPM symbols is one chip ahead of the symbol clock of the transmission synchronization pattern Tx and of the reception synchronization pattern Rx. The symbol clock of the data sequence illustrated on the time axis 12 corresponds to the time clock of the transmission synchronization pattern Tx and of the reception synchronization pattern Rx.

The symbol clock of the data sequence illustrated on the time axis 13 is one chip behind the symbol clock of the transmission synchronization pattern Tx and of the reception synchronization pattern Rx, and the symbol clock of the data sequence illustrated on the time axis 14 is two chips behind the symbol clock of the transmission synchronization pattern Tx and of the reception synchronization pattern Rx.

Although the respective data sequences are selected so as to result in as large as possible a number of correspondences with the reception synchronization pattern Rx, differences are present in each case in 3 places. These places at which the reception synchronization pattern Rx and the 4-PPM data sequence (example) differ are marked with dots.

In order for the synchronization moment to be detected correctly, the Hamming distance of 3 is also guaranteed whenever a shifted transmission synchronization pattern Tx with adjacent data is located in the shift register of a synchronization detector.

It is possible by means of such a pattern to send the synchronization pattern at any desired moments and not only within a training sequence at the start of a data transmission. It is possible, for example, to send the pattern before each ATM cell in the case of ATM (Asynchronous Transfer Mode) data transmission. Correct reception of the next ATM cell is ensured thereby even after a synchronization loss.

FIG. 4 shows a synchronization detector by means of which it is possible to carry out a continuous comparison of the received chip sequence with the reception synchronization pattern Rx. The synchronization detector has an N-place shift register 20 for this purpose. As illustrated by the arrow 21, the shift register 20 is fed the data stream of the received chip sequences on the input side. The synchronization detector has a static data memory 22 of length N in which the reception synchronization pattern Rx is stored. The shift register 20 and the static data memory 21 each have N parallel outputs. The length N of the data memory 22 and of the shift register 20 corresponds to the length N of the reception synchronization pattern Rx. The N parallel outputs of the data memory 22 and of the shift register 20 are coupled in pairs to the respective inputs of equivalence gates 23. The outputs of the equivalence gates 23 are coupled to the input of a threshold value discriminator 24. The data signal stored in the shift register 20 is compared bit by bit with the reception synchronization pattern Rx stored in the data memory 22 by means of the equivalence gates 23. The outputs signals of the equivalence gates 23 are added in the threshold value discriminator 24. The threshold value discriminator generates a synchronization pulse 25 upon overshooting of a prescribable threshold value. The threshold value is determined by the number of correctable errors. The reception synchronization pattern Rx of FIG. 3 differs in at least 3 places from each possible valid 4-PPM sequence, and therefore has the Hamming distance relating to all valid data signals. In the case of this pattern, the threshold value can be fixed, for example, at a value of 1, 2 or 3, depending on which error probability is required for the non-detection or the imitation of the reception synchronization pattern Rx.

The expenditure for the threshold value discrimination 24 can be kept low, in particular by virtue of the fact that the addition of the outputs of the equivalence gates 23 with logic value “0” (non-correspondences) takes place only modulo C+2.

FIGS. 5 to 8 show by way of example transmission synchronization patterns Tx and reception synchronization patterns Rx for 4-PPM.

In this case, patterns are shown for the Hamming distance 3 in FIG. 5, for the Hamming distance 4 in FIG. 6, for the Hamming distance 5 in FIG. 7, and for the Hamming distance 6 in FIG. 8. Tx and Rx patterns are always specified in pairs, the Tx pattern being illustrated first, and then the Rx pattern.

The following criteria were taken into account in selecting the patterns:

It was taken into account as the first criterion that the Tx pattern has the same mean value as the associated PPM signal, that is to say 1/L). Although it is possible with OOK signals to achieve satisfactory Hamming distances between the pattern and signal even with short patterns, it is necessary before and/or after the pattern to insert an additional sequence within which the receiver can be set to the changed signal mean value. This sequence alone is 32 chips long, for example, in the case of the synchronization method standardized in the IEEE 820.11 Standard.

It was taken into account as the second criterion that the Tx pattern has high-pass characteristics similar to an L-PPM sequence. Consequently, during the pattern search the selection was limited to the following patterns, which have the following characteristics in comparison with PPM data sequences:

| Valid PPM sequence | Pattern |
|---|---|
| max. 2 >>1<< chips in L + 1 chips | max. 2 >>1<< chips in L + 1 chips |
| max. 3 >>1<< chips in 2L + 1 chips | max. 3 >>1<< chips in 2L chips |
| max. 4 >>1<< chips in 3L + 1 chips | — |
| . . . | — |
| min. 1 >>1<< chip in 2L − chips | min. 1 >>1<< chip in 2L − 1 chips |
| min. 2 >>1<< chips in 3L − 1 chips | min. 1 >>1<< chip in 3L chips |
| min. 3 >>1<< chips in 4L − 1 chips | — |

These boundary conditions may be relaxed or modified for other applications.

Finally, it was taken into account as the third criterion that the reception synchronization pattern Rx has a minimum Hamming distance relative to all the valid PPM data sequences, independently of their phase angle (in the chip) and relative to all the shifted versions of the transmission synchronization pattern Tx (which is adjoined by valid PPM symbols). It is thereby possible to send the pattern at any desired moments, and not only within a training sequence. In the concrete example of the IR system, the pattern is sent before each ATM cell. Consequently, the correct reception of the next ATM cell is ensured even after a synchronization loss.

The search was carried out by means of a computer program and limited to transmission synchronization patterns Tx whose length is a multiple of L=4. The minimum length Ntx of the transmission synchronization pattern Tx for which the above conditions are fulfilled is given for each Hamming distance. Since the number of patterns can be very large, only those patterns are specified for which the length Nrx of the reception synchronization pattern Rx is a minimum. The mirrored variants always apply in addition to the specified patterns. For Tx pattern lengths of up to 3 bytes, patterns up to a Hamming distance of dh=6 were found.

Depending on the application and requirements of the communication system, the above criteria may also be modified and/or other criteria may be set and, consequently, alternative patterns may be found by means of computer simulation.

The synchronization error probability must be distinguished between the probability of a transmitted pattern not being detected and the probability of a synchronization pulse being generated in error during a PPM data sequence (false alarm). The two probabilities are denoted by p e, loss, and p e,!alse, respectively.

If the length of the Rx pattern is Nrx, and if dc errors are tolerated by the discriminator threshold, a sent pattern is not detected with the probability:

$${P}_{e , loss} = 1 - {( 1 - {P}_{e , chip} )}^{{N}_{rx}} - {\sum }_{i = 1}^{{d}_{c}} ( \begin{matrix}{N}_{rx} \\ i\end{matrix} ) {{P}_{e , chip}^{i} ( 1 - {P}_{e , chip} )}^{{N}_{rx} - j} \qquad ( 1 )$$

P_{e,chip} is the chip error probability. In contrast thereto, a false alarm occurs when at least dₕ−d_{c}, errors occur within the at least dₕ different chip positions (dₕ: Hamming distance). For each chip clock pulse, the probability of a false alarm is:

$${P}_{e , false} \leq {\sum }_{i = ( {d}_{h} - {d}_{c} ( )}^{{d}_{h}} ( \begin{matrix}{d}_{h} \\ i\end{matrix} ) {{P}_{e , chip}^{i} ( 1 - {P}_{e , chip} )}^{{d}_{h} - i} \qquad ( 2 )$$

The equality symbol is valid, however, only when a PPM data sequence is sent which differs from the Rx pattern at no more than dh places. The probability of such a combination was determined by straightforward simulation for various Rx patterns of distances 5 and 6. It was less than 1/1000 in all cases. It follows that for equally likely data it is possible to multiply (2) by (J/1OOO) for the purpose of a rough estimate. It is substantially simpler to search for the pattern only at the beginning of a transmission following a defined training sequence and the carrier detection, and to terminate this search after successful detection. In this case, the pattern need be distinguished only from the training sequence and not from every possible PPM data sequence in order not to be falsely detected.

1. A communication system with means for transmitting a data stream via a transmission medium by means of time slot coding, wherein a synchronization pattern is provided for insertion into the data stream, in which the synchronization pattern is selected such that it differs by a prescribable Hamming distance from all the valid data signals of the time slot coding independently of the respective time slot of the data signals, and that it differs by a prescribable Hamming distance from all time-shifted versions of the synchronization pattern.

2. A communication system as claimed in claim 1, characterized in that the prescribable Hamming distance is greater than or equal to 2.

3. A communication system as claimed in claim 1, characterized in that a synchronization detector is provided for continuous comparison of the received data stream with the synchronization pattern, and wherein the synchronization detector is provided for generating a synchronization pulse when the Hamming distance between the received data stream and the synchronization pattern undershoots a prescribable threshold value.

4. A communication system as claimed in claim 3, characterized in that the communication system is a TDMA (Time Division Multiple Access) system, and in that the synchronization detector is provided both for symbol synchronization of the time slot coding and for frame synchronization of the TDMA time frame.

5. A communication system as claimed in claim 3, characterized in that the synchronization detector has a shift register with parallel outputs, to which the data stream is fed on the input side, in that the synchronization pattern is stored in the synchronization detector, and in that the synchronization detector is provided for pairwise comparison of the stored synchronization pattern with the output signals of the shift register.

6. A synchronization detector for detecting a synchronization pattern within a data stream of a time-slot-coded signal, which synchronization detector has a shift register with parallel outputs to which the data stream is fed on the input side, in which the synchronization pattern is stored in the synchronization detector, and in which the synchronization detector is provided for pairwise comparison of the stored synchronization pattern with the output signals of the shift register.

7. A time-slot-coded signal which receives at regular time intervals a synchronization pattern which is selected such that it differs by a prescribable Hamming distance from all the valid data signals of the time slot coding independently of the respective time slot of the data signals, and that it differs by a prescribable Hamming distance from all time-shifted versions of the synchronization pattern.

8. A method of transmitting a data stream via a transmission medium by means of time slot coding, wherein a synchronization pattern is provided for insertion into the data stream, which pattern is selected such that it differs by a prescribable Hamming distance from all the valid data signals of the time slot coding independently of the respective time slot of the data signals, and that it differs by a prescribable Hamming distance from all time-shifted versions of the synchronization pattern.

9. A terminal for a communication system with means for transmitting a data stream via a transmission medium by means of time slot coding, wherein a synchronization pattern is provided for insertion into the data stream, in which the synchronization pattern is selected such that it differs by a prescribable Hamming distance from all the valid data signals of the time slot coding independently of the respective time slot of the data signals, and that it differs by a prescribable Hamming distance from all time-shifted versions of the synchronization pattern.
